(19) United States
(12) Patent Application Publication
(10) Pub. No.: US 2008/0310547 A1
(43) Pub. Date: Dec. 18, 2008

(54) Multi-code precoding for sequence modulation

(75) Inventors: Esa Tiirola, Kempele (FI); Kari Hooli, Oulu (FI); Kari Pajukoski, Oulu (FI)

Correspondence Address: HARRINGTON & SMITH, PC, 4 RESEARCH DRIVE, Suite 202, SHELTON, CT, 06484-6212, US

(73) Assignee: Nokia Siemens Networks Oy

(21) Appl. No.: 12/157,113

(22) Filed: Jun. 6, 2008

Related U.S. Application Data
(60) Provisional application No. 60/933,750, filed on Jun. 8, 2007.
(60) Provisional application No. 60/933,760, filed on Jun. 8, 2007.

(51) Int. Cl. H04L 27/00

(52) U.S. Cl. 375/296

(57) ABSTRACT

In accordance with an exemplary embodiment of the invention a method is provided to reduce a peak to average ratio with a multi-code transmission. The method includes precoding a plurality of symbols, modulating the precoded plurality of symbols using multi-codes including a plurality of orthogonal codes, and transmitting a signal comprising the modulated precoded plurality of symbols, where precoding is performed to reduce the peak to average ratio of the transmitted signal.

### CROSS-REFERENCE TO RELATED APPLICATIONS:

This patent application claims priority under 35 U.S.C. §119(e) from Provisional Patent Application No.: 60/933,760, filed Jun. 8, 2007 the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for transmitting information between a user device and a wireless network device.

### BACKGROUND

Certain abbreviations that may be found in the description and/or in the Figures are herewith defined as follows:
3GPP Third Generation Partnership Project
ACK acknowledgement
CAZAC constant-amplitude zero auto-correlation
CDM code division multiplexing
CDMA code division multiple access
CM cubic metric
CP cyclic prefix
CQI channel quality indicator
DFT discrete Fourier transform
E-UTRAN evolved UTRAN
FDD frequency division duplex
FDM frequency division multiplexing
FDMA frequency division multiple access
FFT fast Fourier transform
HARQ hybrid automatic repeat request
IFFT inverse FFT
LB long block
LTE long term evolution
NACK negative acknowledgement
Node B Base Station
eNode B EUTRAN Node B (eNB)
OFDM orthogonal frequency domain multiplex
PAR peak to average ratio
PRB physical resource block
PUCCH physical uplink control channel
QPSK quadrature phase shift keying
SC subcarrier
SC-FDMA single carrier, frequency division multiple access
SNR signal to noise ratio
TDD time division duplex
UE user equipment
UL uplink
UTRAN universal terrestrial radio access network
DFT-S-OFDM discrete Fourier transform spread OFDM (SC-FDMA based on frequency domain processing)
WCDMA wideband code division multiple access
ZAC zero auto-correlation

A communication system known as evolved UTRAN (E-UTRAN, also referred to as UTRAN-LTE) has been under discussion within the 3GPP. A working assumption has been that the DL access technique can be OFDMA, and the UL technique can be SC-FDMA.

Reference can be made to 3GPP TS 36.211, V1.0.0 (2007-03), 3rd Generation Partnership Project; Technical Specification Group Radio Access Network; Physical Channels and Modulation (Release 8) for a description in Section 6 of the UL physical channels.

FIG. 1A reproduces FIG. 12 of 3GPP TS 36.211 and shows the UL slot format for a generic frame structure.

As is described in Section 9.1 of 3GPP TR 25.814, the basic uplink transmission scheme is single-carrier transmission (SC-FDMA) with cyclic prefix to achieve uplink inter-user orthogonality and to enable efficient frequency-domain equalization at the receiver side. Frequency-domain generation of the signal, sometimes known as DFT-spread OFDM (DFT S-OFDM), is assumed.

FIG. 1B shows the generation of pilot samples. An extended or truncated Zadoff-Chu symbol sequence is applied to an IFFT block via a sub-carrier mapping block. The sub-carrier mapping block determines which part of the spectrum is used for transmission by inserting a suitable number of zeros at the upper and/or lower end. A CP is inserted into the output of the IFFT block.

In the PUCCH sub-frame structure for the UL control signaling seven SC-FDMA symbols (also referred to herein as “LBs” for convenience) are currently defined per slot. A sub-frame consists of two slots. Part of the LBs are used for reference signals (pilot long blocks) for coherent demodulation. The remaining LBs are used for control and/or data transmission.

The current working assumption is that for the PUCCH the multiplexing within a PRB is performed using CDM and (localized) FDM is used for different resource blocks. In the PUCCH the bandwidth of one control and pilot signal always corresponds to one PRB=12 SCs.

Two types of CDM multiplexing are used both for data and pilot LBs. Multiplexing based on the usage of cyclic shifts provides nearly complete orthogonality between different cyclic shifts, if the length of cyclic shift is larger than the delay spread of radio channel. For example, with an assumption of a 5 microsecond delay spread in the radio channel, up to 12 orthogonal cyclic shifts within one LB can be achieved. Sequence sets for different cells are obtained by changing the sequence index.

Another type of CDM multiplexing may be applied between LBs based on orthogonal covering sequences, e.g., Walsh or DFT spreading. This orthogonal covering may be used separately for those LBs corresponding to the RS and those LBs corresponding to the data signal. The CQI is typically transmitted without orthogonal covering.

Of particular interest to the exemplary embodiments of this invention is control channel signaling and, in particular, the use of the PUCCH.

More specifically, the exemplary embodiments of this invention pertain to DL CQI modulation in the UL PUCCH channel. It has been determined in 3GPP that UEs having a CQI transmission are CDM-multiplexed by means of different cyclic shifts of CAZAC sequences.

However, a problem that arises in relation to CAZAC sequence modulation is the significant reduction in spectrum efficiency, since only one modulated CAZAC sequence can be transmitted by a particular UE during a LB. Correspondingly, the maximum symbol rate per UE is limited to one symbol per block. While the spectrum efficiency could be increased by transmitting multiple modulated CAZAC sequences simultaneously, this approach would suffer from a high PAR (peak-to-average ratio) requiring either increased UE power consumption or a decrease in CQI coverage.

### SUMMARY

In an exemplary aspect of the invention there is a method comprising precoding a plurality of symbols, modulating the precoded plurality of symbols using multi-codes comprised of a plurality of orthogonal codes, and transmitting a signal that comprises the modulated precoded plurality of symbols, where the precoding is performed to reduce a peak to average ratio of the transmitted signal.

In another exemplary aspect of the invention, there is a computer program embodied on a memory and executable by a processor to perform operations comprising precoding a plurality of symbols, modulating the precoded plurality of symbols using multi-codes comprised of a plurality of orthogonal codes, and transmitting a signal that comprises the modulated precoded plurality of symbols, where the preceding is performed to reduce a peak to average ratio of the transmitted signal.

In another exemplary aspect of the invention, there is an apparatus, comprising a precoder configured to precode a plurality of symbols, a modulator configured to modulate the precoded plurality of symbols using multi-codes comprised of a plurality of orthogonal codes, and a transmitter configure to transmit a signal that comprises the modulated precoded plurality of symbols, where the preceding is performed to reduce a peak to average ratio of the transmitted signal.

In yet another exemplary aspect of the invention, there is an apparatus, comprising means for precoding a plurality of symbols, means for modulating the precoded plurality of symbols using multi-codes comprised of a plurality of orthogonal codes, and means for transmitting a signal that comprises the modulated precoded plurality of symbols, where the precoding is performed to reduce a peak to average ratio of the transmitted signal.

Further, in the exemplary aspect of the invention above the means for preceding comprises a precoder, the means for modulating comprises a modulator, and the means for transmitting comprises a transmitter.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A reproduces FIG. 12 of 3GPP TS 36.211 and shows the UL slot format for a generic frame structure .

FIG. 1B is a block diagram that illustrates the generation of pilot samples for the 3GPP LTE SC-FDMA UL.

FIG. 2 shows a simplified block diagram of various electronic devices that are suitable for use in practicing the exemplary embodiments of this invention.

FIG. 3 is a logic flow diagram in accordance with exemplary embodiments of a method, and a computer program product, in accordance with this invention.

FIG. 4A is a block diagram showing in greater detail an LTE-type of transmitter that is constructed to include a modulation and precoding block in accordance with embodiments of this invention.

FIG. 4B is a block diagram showing in greater detail an LTE-type of transmitter that is constructed to include a constellation mapping table in accordance with embodiments of this invention.

FIG. 4C is a block diagram showing an alternative structure for an LTE-type of transmitter that is constructed to include a constellation mapping table in accordance with embodiments of this invention.

FIG. 5 depicts the principle of DFT preceding.

FIG. 6A shows a table descriptive of an exemplary four-bit mapping into two complex-valued modulated symbols, x=I+jQ.

FIG. 6B shows a table descriptive of an exemplary four-bit mapping into four complex-valued modulated symbols, x=I+jQ.

FIG. 7 is a graph that presents a performance comparison between single-code (1 Code) and multi-code (2 Codes) operation.

FIG. 8 is a graph showing the CM of two multi-code transmissions with and without DFT preceding.

FIG. 9A shows the construction of composite sequences from the sequences used in the multi-code modulation.

FIG. 9B shows the construction of composite sequences from the sequences used in the multi-code modulation in the frequency domain.

### DETAILED DESCRIPTION

The exemplary embodiments of this invention provide in at least one aspect thereof an enhancement for ZAC sequence modulation that utilizes a precoding technique for reducing PAR with a multi-code transmission.

It can be noted at the outset that the use of multi-codes is known in the WCDMA UL system, however, sequence modulation is not used in the WCDMA system.

Further, it is noted that ZAC includes CAZAC and other codes. To the extent the description refers to CAZAC, more general ZAC also applies.

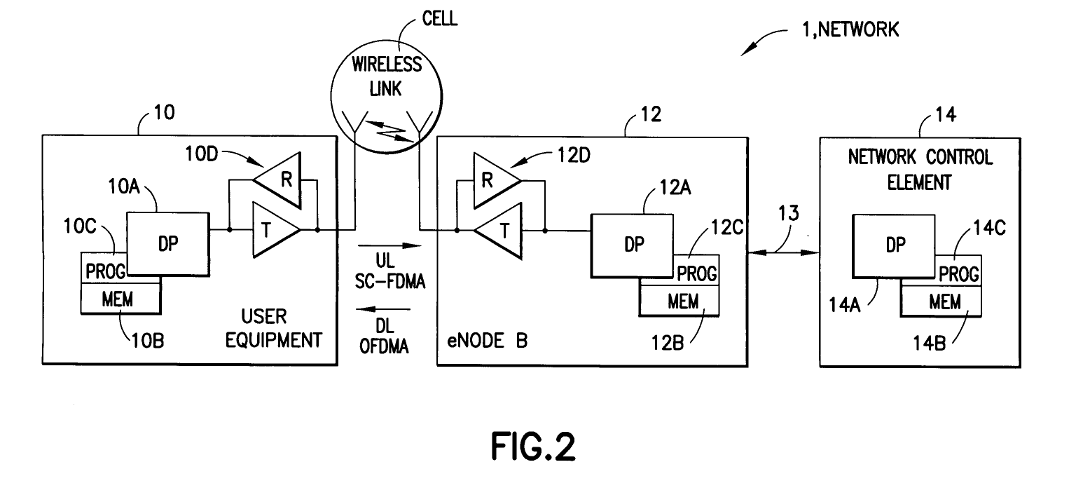

By way of introduction, reference is made to FIG. 2 for illustrating a simplified block diagram of various electronic devices that are suitable for use in practicing the exemplary embodiments of this invention. In FIG. 2 a wireless network 1 is adapted for communication with a UE 10 via at least one Node B (base station) 12 (also referred to herein as an eNode B 12). The network 1 may include a network control element 14 coupled to the eNode B 12 via a data path 13. The UE 10 includes a data processor (DP) 10A, a memory (MEM) 10B that stores a program (PROG) 10C, and a suitable radio frequency (RF) transceiver 10D having a transmitter (T) and a receiver (R) for bidirectional wireless communications with the eNode B 12, which also includes a DP 12A, a MEM 12B that stores a PROG 12C, and a suitable RF transceiver 12D having a transmitter (T) and a receiver (R). The eNode B 12 is typically coupled via the data path 13 to the network control element 14 that also includes at least one DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

In a typical implementation there will be a plurality of UEs 10 that are present and that require the use of UL signaling.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10 and the DP 12A of the eNode B 12, or by hardware, or by a combination of software (and firmware) and hardware.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

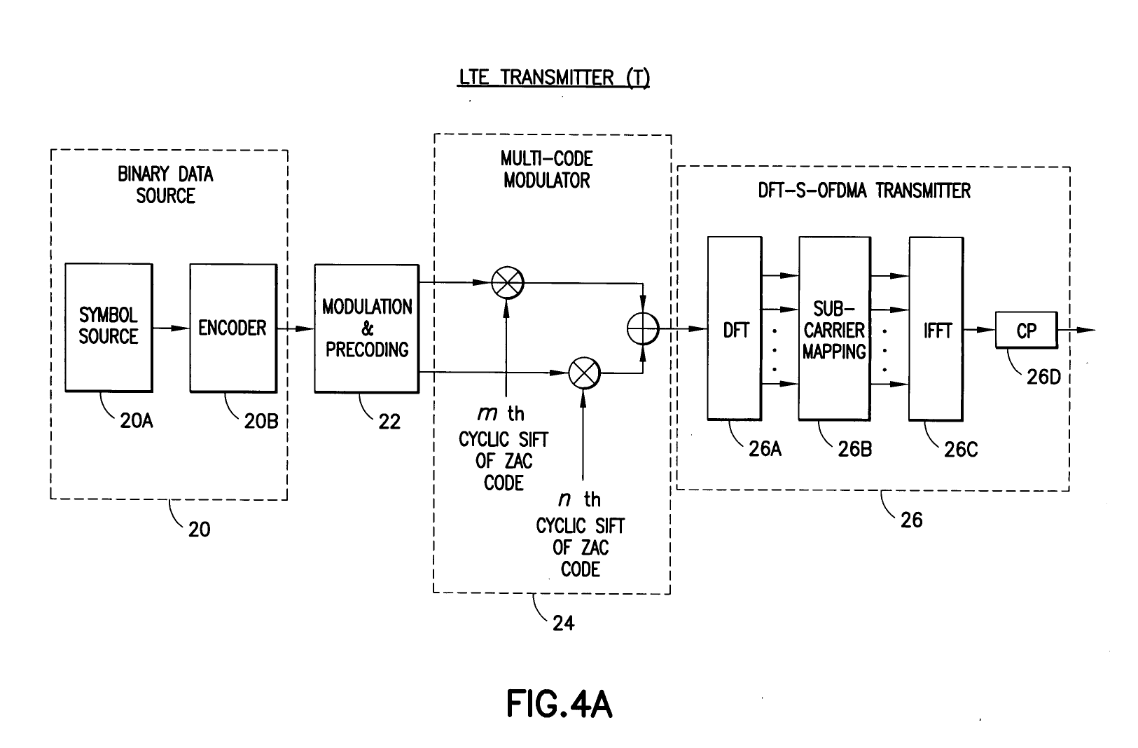

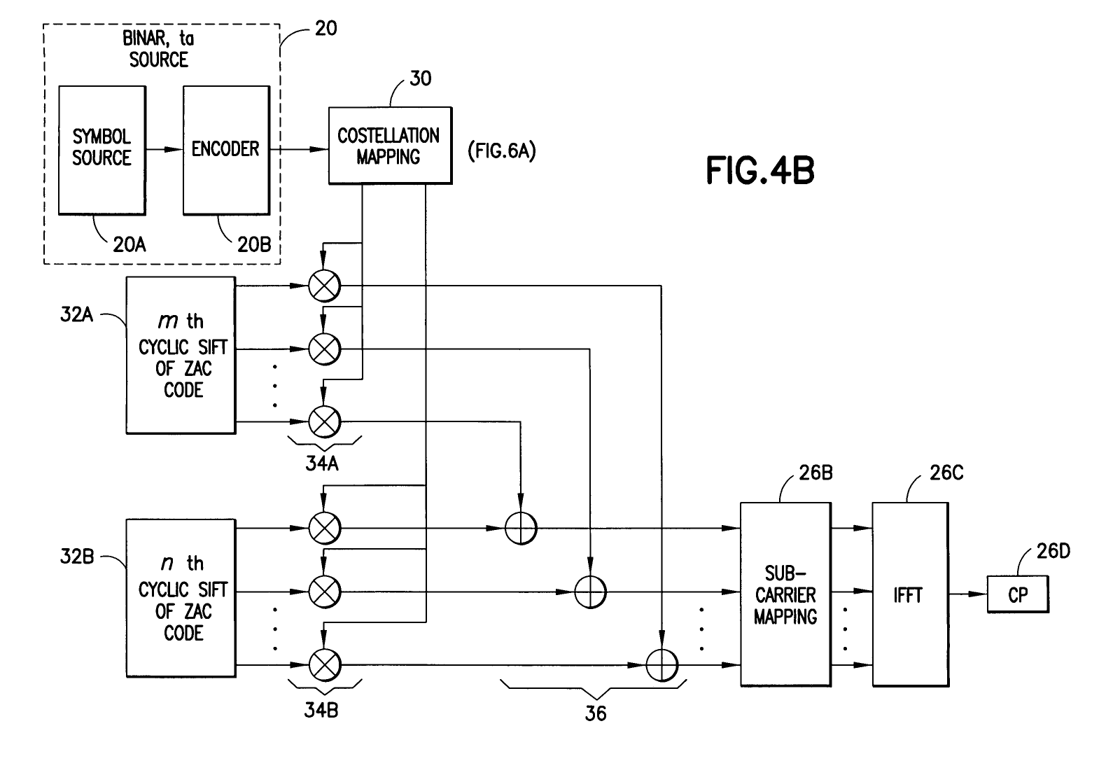

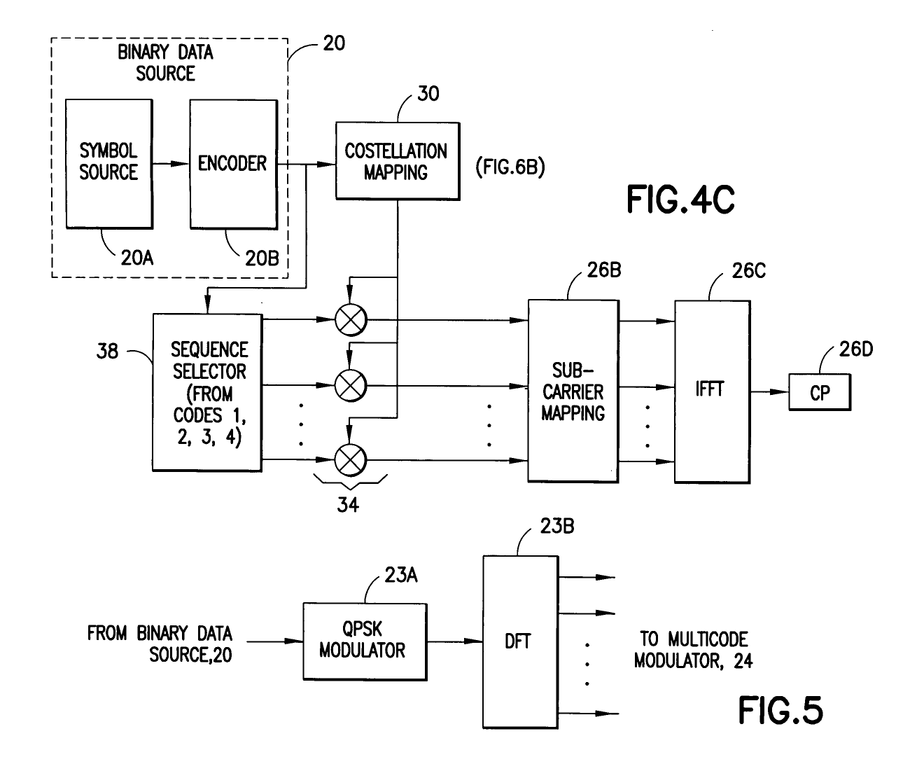

Discussing now in greater detail the exemplary embodiments of this invention, a particular precoding scheme is provided to reduce PAR (e.g. peak to average power ratio) with a multi-code transmission. The location of a precoding block in the LTE transmitter (T) is shown in FIG. 4A. More specifically, the exemplary embodiments of this invention may be practiced using a binary data source 20 having a bit source 20A and an encoder 20B. The output of the encoder 20B is an input to a modulation and preceding block 22 that is constructed and operated in accordance with the exemplary embodiments of this invention. After modulating and preceding the encoded symbols the output of the block 22 is input to a multi-code modulator 24 where the modulated and precoded symbol stream is multiplied by mth and nth cyclic shifts of the ZAC code. The modulated signals are combined and input to a DFT-S-OFDMA transmitter block 26 that includes, in sequence, a DFT block 26A, a sub-carrier mapping block 26B, an IFFT block 26C and a CP block 26D (see, for example, Section 9.1.1, Basic Transmission Scheme, of 3GPP TR 25.814, V7.1.0 (2006-09)). The resulting signal is subsequently transmitted over the air interface.

Further, it is noted that to the extent the description refers to bits, symbols can also apply (and vice versa).

The operation of the modulation and precoding block 22 can be implemented, as two non-limiting examples, by a DFT spreader or by specific constellation mapping table.

The basic principle of DFT spreading is shown in FIG. 5, where an input of a DFT spreader 23B is a block of symbols output from a QPSK modulator 23A. DFT operation generates a block of symbols for the multi-code modulator 24. The size of the DFT input and output is equal to the number of multi-codes in use.

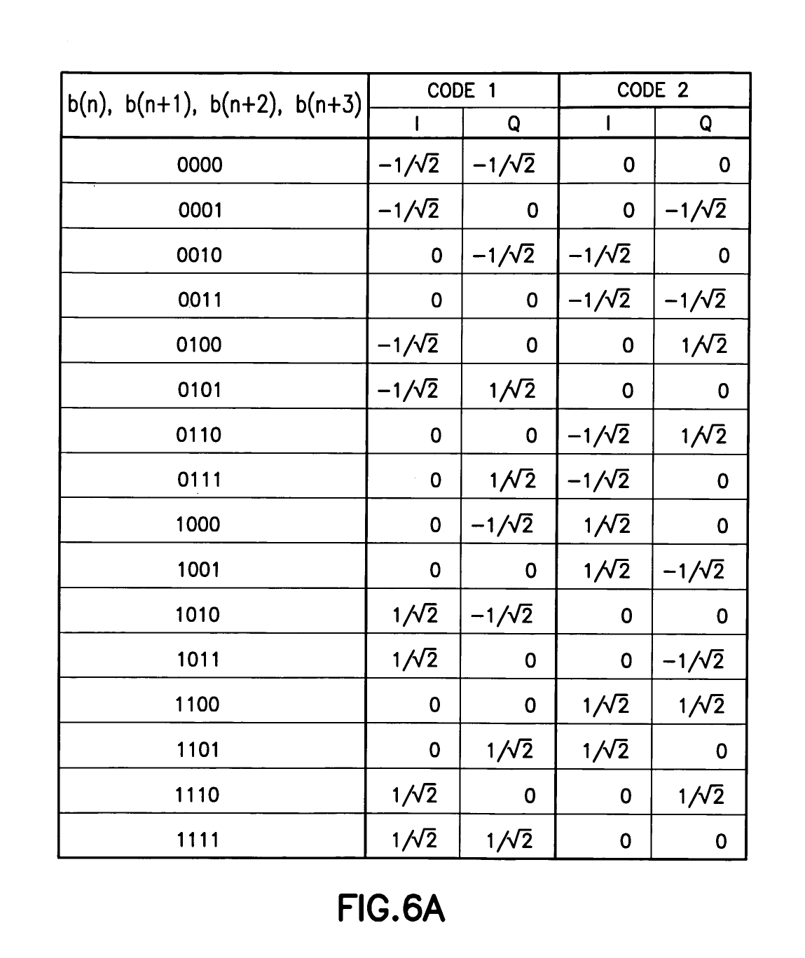

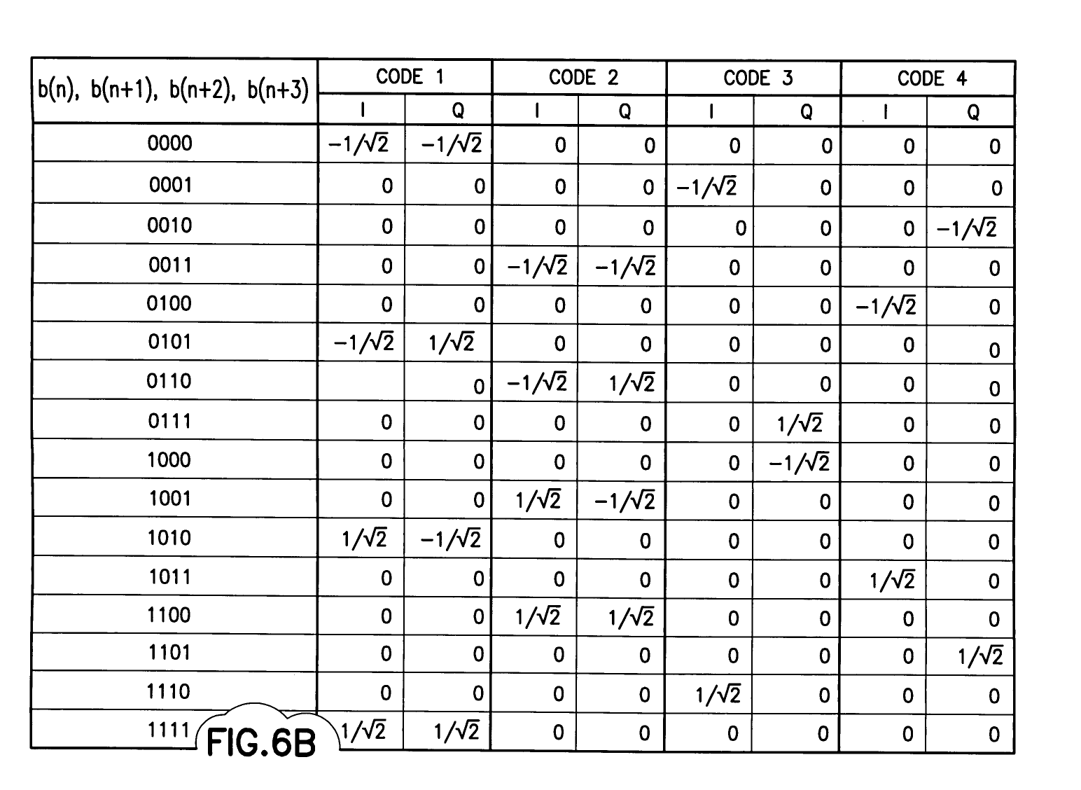

The principle of the constellation mapping table is shown in FIG. 6A, which shows a direct constellation mapping table with two multi-codes. The table of FIG. 6A presents the mapping for all possible four-bit signaling words (b(n), b(n+1), b(n+2), b(n+3)) into two modulated complex-valued symbols (Code 1, Code 2). It should be noted that the constellation mapping based on the table of FIG. 6A may result in reduced UE 10 complexity, at least when using a small number (e.g., two) of multi-codes. A corresponding transmitter for the case of two multi-codes is shown in FIG. 4B.

In FIG. 4B those components found in FIG. 4A are numbered accordingly. FIG. 4B additionally shows a constellation mapping block 30 that implements the exemplary two code mapping table shown in FIG. 6A. Outputs of the constellation mapping block 30 are applied to multipliers 34A, 34B whose other inputs are provided by blocks 32A, 32B, respectively, representing the mth and nth cyclic shifts of the ZAC code, respectively. The outputs of the multipliers 34A, 34B are combined in circuitry 36 and then applied to the sub-carrier mapping block 26B.

Another example of constellation mapping table is given in FIG. 6B, which shows an alternative constellation mapping table with multi-codes. The table of FIG. 6B presents the mapping for all possible four-bit signaling words (b(n), b(n+1), b(n+2), b(n+3)) into four modulated complex-valued symbols, each symbol modulating a single composite sequence (Code 1, Code 2, Code 3, Code 4) constructed from two ZAC sequences used in the multi-code modulation. The corresponding transmitter for this case is shown in FIG. 4C, and includes a sequence selector block (from the Codes 1-4) 38 and the multiplier 34.

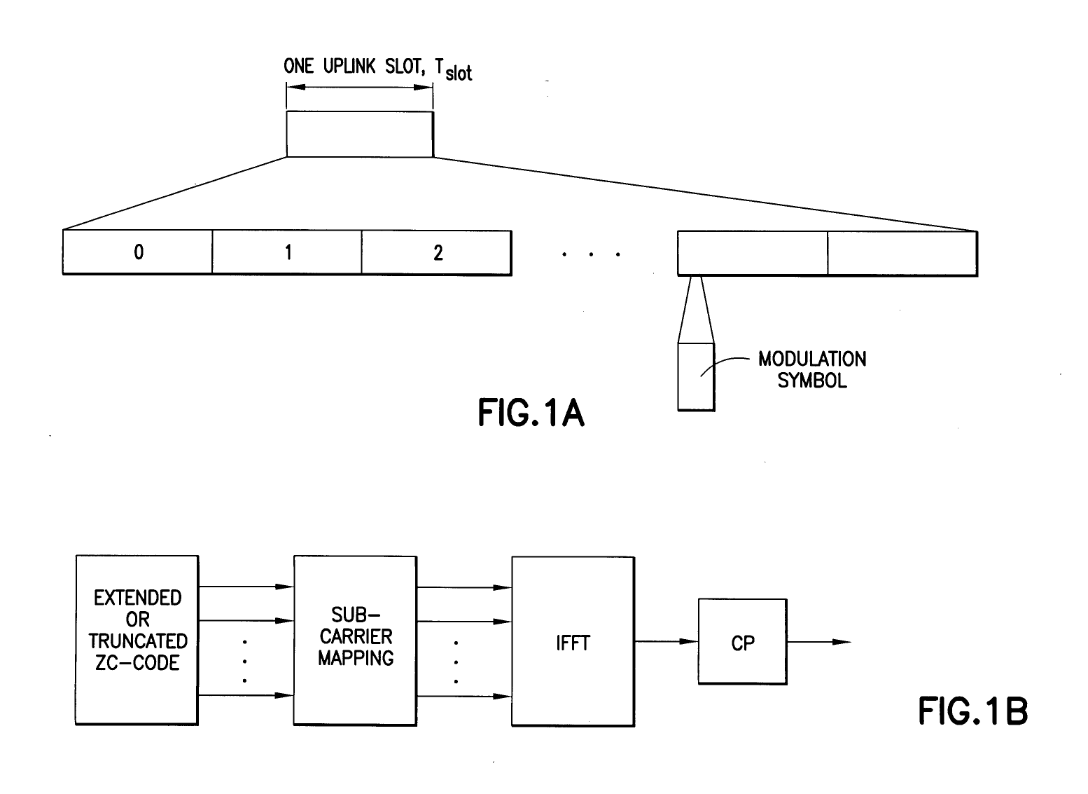

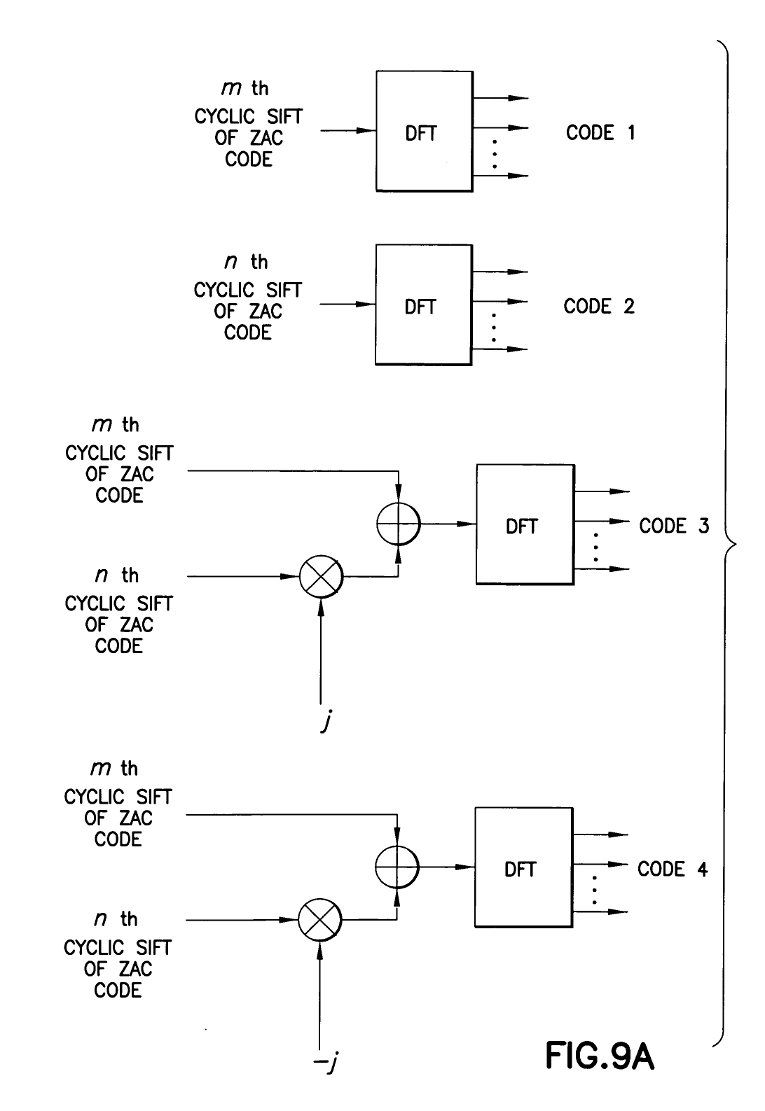

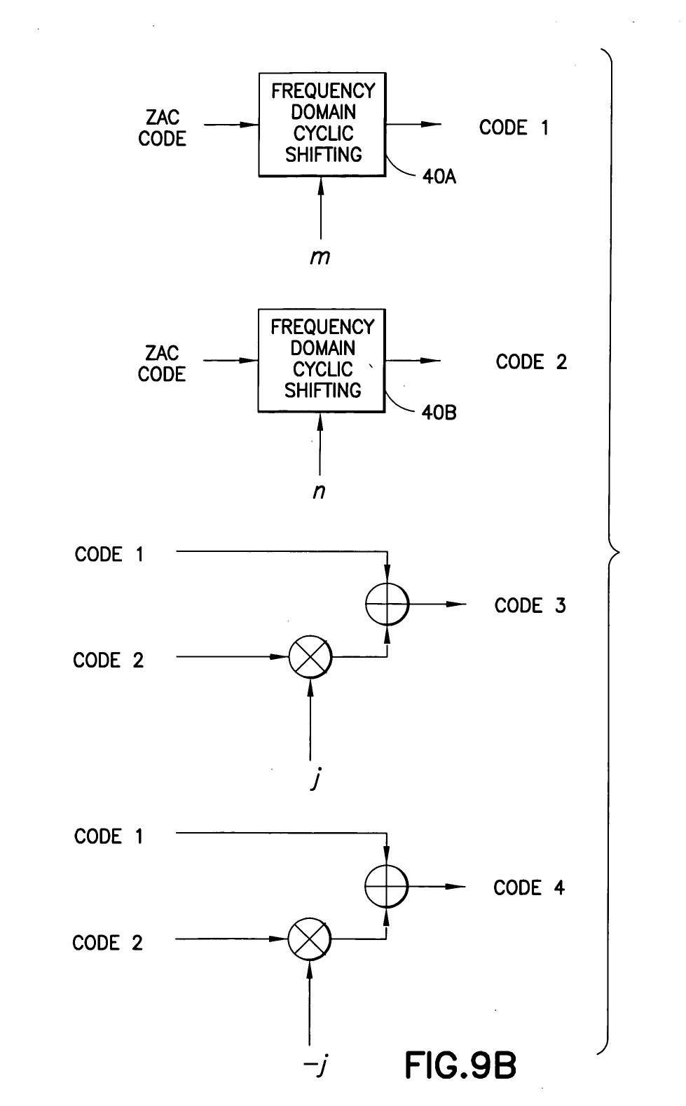

An embodiment of circuitry to construct the composite sequences Code 1, Code 2, Code3, and Code 4 is shown in FIG. 9A. An alternative embodiment for constructing the composite sequences in the frequency domain is shown in FIG. 9B. In FIG. 9B, the frequency domain cyclic shifting blocks 40A, 40B perform a time domain cyclic shift by rotating each of the sequence elements by a particular angle. The embodiment of FIG. 9B may be preferable for the case where the ZAC sequences are defined in the frequency domain, as shown in FIG. 1B.

The separation between the ZAC sequence cyclic shifts used in the multi-code modulator 24 is preferably N/m, where N is the sequence length and m is the number of multi-codes, in order to obtain optimum CM properties. The exemplary embodiments of this invention are, however, not limited to the use of this particular separation. For example, adjacent cyclic shifts of a ZAC sequence may be allocated for different multi-codes. The cyclic shifts of a ZAC sequence may be multiplied with a multiplier specific for that cyclic sequence and that DFT-S-OFDMA symbol. The multiplier may constitute an element of orthogonal sequence used for block-wise spreading over the DFT-S-OFDMA symbols. In other words, different orthogonal sequences may be used for the block-wise spreading of the cyclic shifts of a ZAC sequence. This non-limiting exemplary embodiment of the invention may be applicable in the case of multi-ACK/NACK signaling in time-division duplex (TDD) mode of LTE system. Another use case is the half-duplex mode of LTE FDD system. Multi-ACK/NACK relates to the situation where multiple DL packets transmitted on PDSCH (Physical Downlink Shared Channel) have their own HARQ process and the respective ACK/NACK signaling. Further, this may cause multiple ACK/NACK symbols per UL subframe.

The number of orthogonal sequences available within a cell for the block-wise spreading may be limited by the number of reference signal symbols in a slot. Multi-code transmission can use the same reference signal structure as single-code transmission. At least one of the orthogonal sequences used for block-wise spreading of multi-code transmission may be a sequence that is not available single-code transmissions within the cell. In other words, multi-code transmission may be arranged so that it does not require more UL PUCCH resources than single-code transmission.

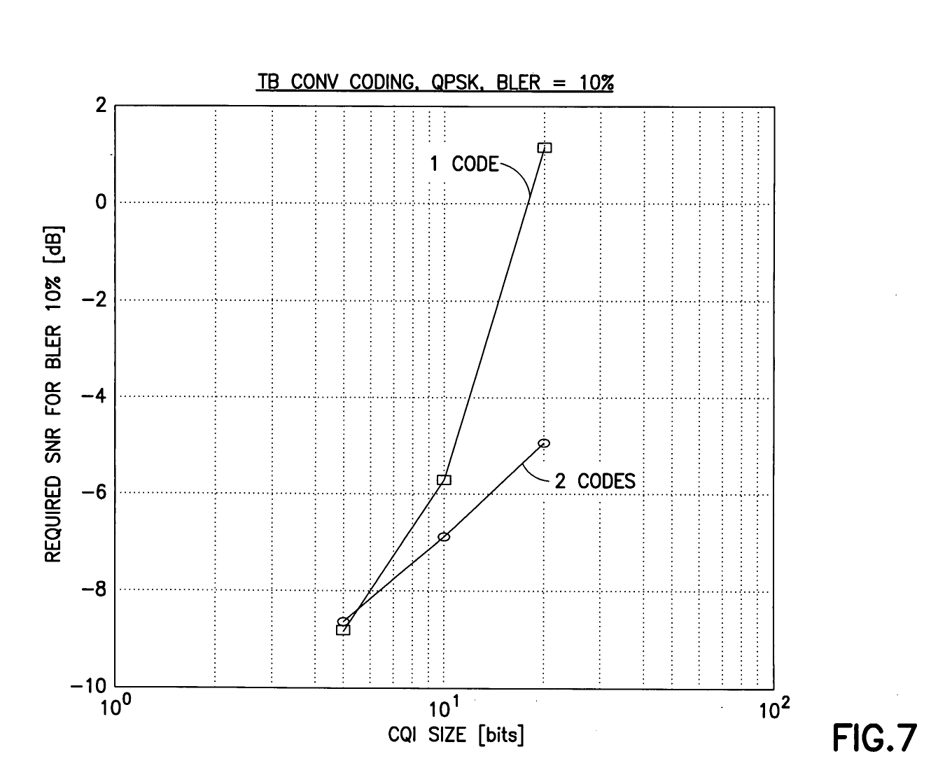

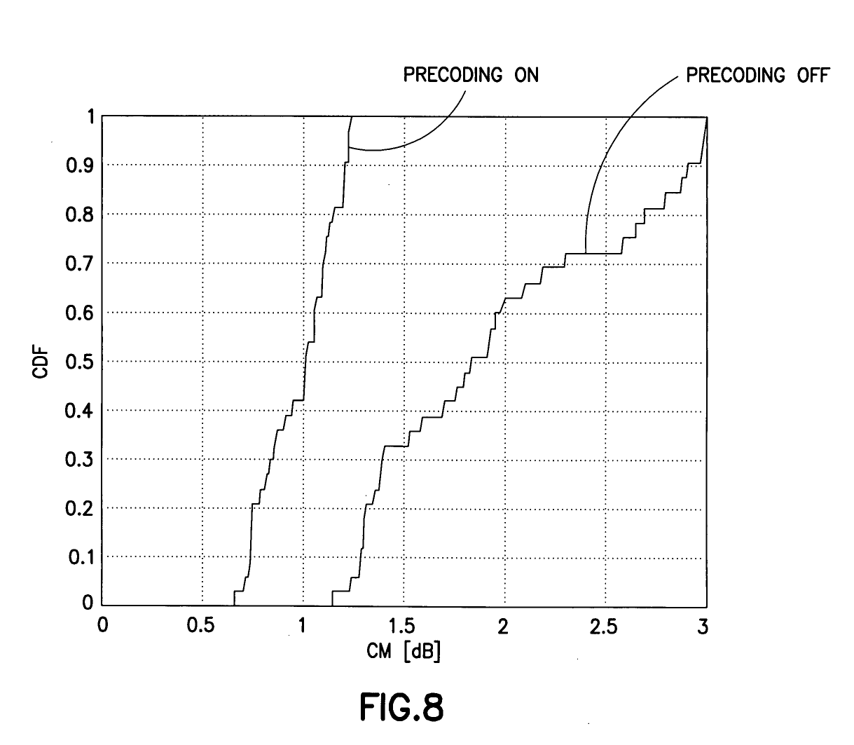

It should be appreciated that the use of the exemplary embodiments of this invention improves the spectrum efficiency of the UL PUCCH, as it allows multi-code transmission without a significant PAR increase. The advantages are demonstrated in FIG. 7 and FIG. 8.

FIG. 7 shows the benefits of multi-code CQI transmission over single code transmission in the terms of required SNR for a certain CQI size. The results show that the technique in accordance with the exemplary embodiments of this invention provide a very significant link performance improvement, especially with CQI packets of 20 symbols (6 dB), while the gain with a 10 symbol CQI message is still greater than 1 dB. One reason for this significant performance improvement is the increased coding gain. One may note that the symbol rate of a dual-code transmission is twice that of a single-code transmission.

FIG. 8 shows a benefit derived by the use of the exemplary embodiments of this invention in the terms of CM reduction. The CM is analyzed for 33 random CAZAC sequences. With the precoding technique in accordance with the exemplary embodiments of this invention all of the 33 sequences have a CM that is less than 1.3 dB, and approximately half of the sequences have a CM less than 1 dB, which is a typical value for QPSK data modulation.

By the use of the exemplary embodiments of this invention a larger size CQI report can be transmitted from the UE 10 to the eNB 12 (due to the use of multi-codes), enabling more efficient usage of the system UL bandwidth and resources, while still constraining the increase in PAR due to the presence of the multi-code transmission.

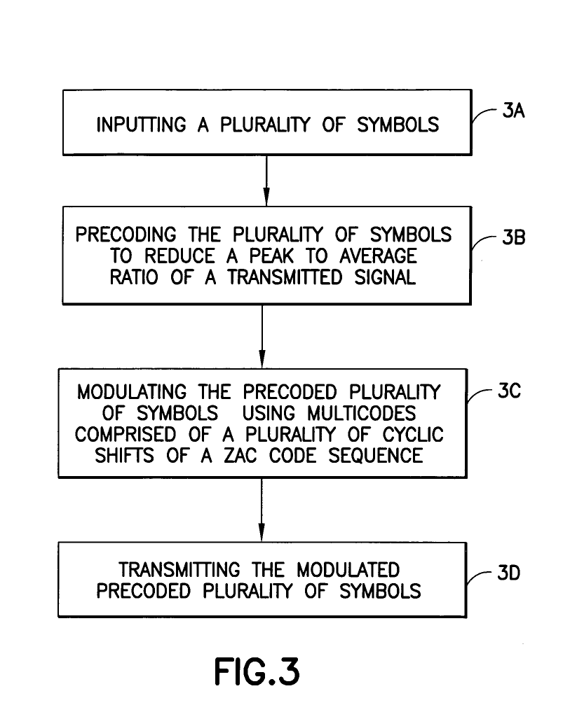

Based on the foregoing it should be apparent that the exemplary embodiments of this invention provide for, in a non-limiting aspect thereof, a method, apparatus and computer program product, as shown in FIG. 3, for:
(A) inputting a plurality of symbols (Block 3A), for precoding the plurality of symbols (Block 3B), for modulating the precoded plurality of symbols using multi-codes comprised of a plurality of cyclic shifts of a ZAC code sequence (Block 3C), and for transmitting the modulated precoded plurality of symbols (Block 3D), where precoding is performed to reduce a peak to average ratio of a transmitted signal.
(B) The method, apparatus and computer program product of the previous paragraph, where precoding comprises modulating and DFT spreading, where a size of an input and an output of a DFT spreader equals the number of codes of the multi-code.
(C) The method, apparatus and computer program product of paragraph (A), where preceding comprises use of a table to directly map the plurality of symbol to inphase and quadrature values for each of the multi-codes.
(D1) The method, apparatus and computer program product of the previous paragraphs, where a separation between the ZAC sequence cyclic shifts is N/m, where N is the sequence length and m is the number of multi-codes.
(D2) The method, apparatus and computer program product of the previous paragraphs, where adjacent cyclic shifts of a ZAC sequence are allocated for different multi-codes.
(E) The method, apparatus and computer program product of the previous paragraphs, where the plurality of symbols represent a CQI report.
(F) The method, apparatus and computer program product of the previous paragraphs, where the transmitted signal comprises a PUCCH.
(G) The method, apparatus and computer program product of the previous paragraphs, embodied in a user equipment.
(H) The method, apparatus and computer program product of the previous paragraphs, embodied and/or executed in at least one integrated circuit.
(I) The method, apparatus and computer program product of the previous paragraphs, where transmitting comprises applying in sequence to the modulated precoded plurality of symbols at least a sub-carrier mapping operation, an IFFT operation, and a CP insertion operation.

Further in accordance with exemplary embodiments of this invention the UE 10 of FIG. 2 is constructed to contain circuitry configured to precode a plurality of symbols, to modulate the precoded plurality of symbols using multi-codes comprised of a plurality of cyclic shifts of a ZAC code sequence, and to transmit the modulated precoded plurality of symbols, where precoding is performed to reduce a peak to average ratio of a transmitted signal.

The UE of the previous paragraph, where the circuitry configured to precode comprises one of a modulator and a DFT spreader, where a size of an input and an output of the DFT spreader equals the number of codes of the multi-code, or a table stored in a memory used to directly map the plurality of symbols to inphase and quadrature values for each of the multi-codes.

The UE of the previous paragraphs, where a separation between the ZAC sequence cyclic shifts may be N/m, where N is the sequence length and m is the number of multi-codes, or may be based on adjacent cyclic shifts of the ZAC sequence that are allocated for different multi-codes.

The UE of the previous paragraphs, where the plurality of symbols represent a CQI report.

The UE of the previous paragraphs, where the transmitted signal comprises a PUCCH sent to an eNB of an LTE network.

The UE of the previous paragraphs, where the circuitry is embodied at least partially in at least one integrated circuit.

The UE of the previous paragraphs, where a transmitter comprises, in sequence, at least a sub-carrier mapping block, an IFFT block, and a CP insertion block.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Note further that the blocks shown in the logic flow diagram of FIG. 3 may also be viewed as a plurality of interconnected functional circuits/functions that operate as described.

As was noted above, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

As but one example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. Further, the exemplary embodiments of this invention are not constrained for use with any specific frame format, numbers of long blocks within a frame, sub-carrier mapping scheme, type of modulation and/or precoding technique, as non-limiting examples, that may have been referred to above. Further still, multi-codes based on other than cyclic shifts of a ZAC sequence may also be employed in some embodiments of this invention. As a particular example, sequences which have a zero autocorrelation zone property, but which do not have constant amplitude in time, may be employed. Also, and as was noted above, the separation between cyclic shifts of a sequence may be other than N/m. As an example, consecutive cyclic shifts may be used, in particular with sequences having a zero autocorrelation zone property but lacking a constant amplitude in time.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

In addition, it should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

What is claimed is:

1. A method, comprising:
precoding a plurality of symbols;
modulating the precoded plurality of symbols using multi-codes comprised of a plurality of orthogonal codes ; and
transmitting a signal that comprises the modulated precoded plurality of symbols, where the preceding is performed to reduce a peak to average ratio of the transmitted signal.

2. The method of claim 1, where precoding comprises modulating and discrete Fourier transform (DFT) spreading the plurality of symbols, where a size of an input and an output of a DFT spreader equals a number of codes of the multi-code.

3. The method of claim 1, where preceding comprises using a table to directly map the plurality of symbols to inphase and quadrature values for each of the multi-codes.

4. The method of claim 1, where the plurality of orthogonal codes comprises Hadamard codes.

5. The method of claim 1, where the plurality of orthogonal codes comprises discrete Fourier transform (DFT) codes.

6. The method of claim 1, where the plurality of orthogonal codes comprises cyclic shifts of a zero auto-correlation (ZAC) sequence.

7. The method of claim 6, where at least one of the cyclic shifts of the ZAC sequence is multiplied with an element of an orthogonal sequence.

8. The method of claim 7, where the orthogonal sequence is reserved for multi-codes.

9. The method of claim 6, where a separation between the ZAC sequence cyclic shifts is N/m, where N is the sequence length and m is a number of multi-codes.

10. The method of claim 6, where adjacent cyclic shifts of the ZAC sequence are allocated for different multi-codes.

11. The method of claim 1, where the plurality of symbols represent a channel quality indicator (CQI) report.

12. The method of claim 1, where the transmitted signal comprises a physical uplink control channel (PUCCH).

13. The method of claim 1 executed by a user equipment.

14. The method of claim 1 executed by at least one integrated circuit.

15. The method of claim 1, where transmitting comprises applying in sequence to the modulated precoded plurality of symbols at least a sub-carrier mapping operation, an inverse fast Fourier transform (IFFT) operation, and a cyclic prefix (CP) insertion operation.

16. A computer readable medium encoded with a computer program executable by a processor to perform actions comprising:
precoding a plurality of symbols;
modulating the precoded plurality of symbols using multi-codes comprised of a plurality of orthogonal codes; and
transmitting a signal that comprises the modulated precoded plurality of symbols, where the precoding is performed to reduce a peak to average ratio of the transmitted signal.

17. The computer readable medium encoded with a computer program of claim 16, where preceding comprises modulating and discrete Fourier transform (DFT) spreading the plurality of symbols, where a size of an input and an output of a DFT spreader equals a number of codes of the multi-codes.

18. The computer readable medium encoded with a computer program of claim 16, where the plurality of orthogonal codes comprises Hadamard codes.

19. The computer readable medium encoded with a computer program of claim 16, where the plurality of orthogonal codes comprises discrete Fourier transform (DFT) codes.

20. The computer readable medium encoded with a computer program of claim 16, where the plurality of orthogonal codes comprises cyclic shifts of a zero auto-correlation (ZAC) sequence.

21. The computer readable medium encoded with a computer program of claim 20, where at least one of the cyclic shifts of the ZAC sequence is multiplied with an element of an orthogonal sequence.

22. The computer readable medium encoded with a computer program of claim 21, where the orthogonal sequence is reserved for multi-codes.

23. The computer readable medium encoded with a computer program of claim 20, where a separation between the ZAC sequence cyclic shifts is N/m, where N is the sequence length and m is a number of multi-codes.

24. The computer readable medium encoded with a computer program of claim 20, where adjacent cyclic shifts of the ZAC sequence are allocated for different multi-codes.

25. The computer readable medium encoded with a computer program of claim 16, where preceding comprises using a table to directly map the plurality of symbols to inphase and quadrature values for each of the multi-codes.

26. The computer readable medium encoded with a computer program of claim 16, where the plurality of symbols represent a channel quality indicator (CQI) report.

27. The computer readable medium encoded with a computer program of claim 16, where the transmitted signal comprises a physical uplink control channel (PUCCH).

28 The computer readable medium encoded with a computer program of claim 16 executed by a user equipment.

29. The computer readable medium encoded with a computer program of claim 16 executed by at least one integrated circuit.

30. The computer readable medium encoded with a computer program of claim 16, where transmitting comprises applying in sequence to the modulated precoded plurality of symbols at least a sub-carrier mapping operation, an inverse fast Fourier transform (IFFT) operation, and a cyclic prefix (CP) insertion operation.

31. An apparatus, comprising:
a precoder configured to precode a plurality of symbols; and
a modulator configured to modulate the precoded plurality of symbols using multi-codes comprised of a plurality of orthogonal codes, where the precoder operates to reduce a peak to average ratio of a transmitted signal that contains the modulated precoded plurality of symbols.

32. The apparatus of claim 31, where the precoder is configured to modulate and discrete Fourier transform (DFT) spread the plurality of symbols, where a size of an input and an output of a DFT spreader equals a number of codes of the multi-code.

33. The apparatus of claim 31, where the precoder is configured to use a table to directly map the plurality of symbols to inphase and quadrature values for each of the multi-codes.

34. The apparatus of claim 31, where the plurality of orthogonal codes comprises Hadamard codes.

35. The apparatus of claim 31, where the plurality of orthogonal codes comprises discrete Fourier transform (DFT) codes.

36. The apparatus of claim 31, where the plurality of orthogonal codes comprises cyclic shifts of a zero auto-correlation (ZAC) sequence.

37. The apparatus of claim 36, where at least one of the cyclic shifts of the ZAC sequence is multiplied with an element of an orthogonal sequence.

38. The apparatus of claim 37, where the orthogonal sequence is reserved for multi-codes.

39. The apparatus of claim 36, where a separation between ZAC sequence cyclic shifts is N/m, where N is the sequence length and m is a number of multi-codes.

40. The apparatus of claim 36, where adjacent cyclic shifts of the ZAC sequence are allocated for different multi-codes.

41. The apparatus of claim 31, where the plurality of symbols represent a channel quality indicator (CQI) report.

42. The apparatus of claim 31, where the transmitted signal comprises a physical uplink control channel (PUCCH).

43. The apparatus of claim 31 embodied by a user equipment.

44. The apparatus of claim 31 embodied by at least one integrated circuit.

45. The apparatus of claim 31, where the transmitter is further configured to apply in sequence to the modulated precoded plurality of symbols at least a sub-carrier mapping operation, an inverse fast Fourier transform (IFFT) operation, and a cyclic prefix (CP) insertion operation.

46. An apparatus, comprising:
means for preceding a plurality of symbols;
means for modulating the precoded plurality of symbols using multi-codes comprised of a plurality of orthogonal codes; and
means for transmitting a signal that comprises the modulated precoded plurality of symbols, where said precoding means operates to reduce a peak to average ratio of the transmitted signal.

47. The apparatus of claim 46, where the means for precoding comprises means for modulating and discrete Fourier transform (DFT) spreading the plurality of symbols, where a size of an input and an output of a DFT spreader equals a number of codes of the multi-code.

48. The apparatus of claim 46, where the means for preceding comprises a table containing information to directly map the plurality of symbols to inphase and quadrature values for each of the multi-codes.

49. The apparatus of claim 46, where the plurality of orthogonal codes comprises cyclic shifts of a zero auto-correlation (ZAC) sequence.

50. The apparatus of claim 49, where a separation between ZAC sequence cyclic shifts is N/m, where N is the sequence length and m is a number of multi-codes.

51. The apparatus of claim 49, where adjacent cyclic shifts of the ZAC sequence are allocated for different multi-codes.
